(19) United States
(12) Patent Application Publication
(10) Pub. No.: US 2006/0163913 A1
(43) Pub. Date: Jul. 27, 2006

(54) Removable quarter panels for open-air style vehicles

(75) Inventors: James P. Gammon, Troy, MI (US); Gregory C. Miller, Rochester Hills, MI (US)

Correspondence Address: MYERS BIGEL SIBLEY & SAJOVEC, PO BOX 37428, RALEIGH, NC, 27627, US

(73) Assignee: Collins & Aikman Products Co.

(21) Appl. No.: 11/232,326

(22) Filed: Sep. 21, 2005

Related U.S. Application Data
(60) Provisional application No. 60/611,763, filed on Sep. 21, 2004.

(51) Int. Cl. B62D 29/04

(52) U.S. Cl. 296/191

(57) ABSTRACT

An open-air vehicle includes a rear cargo area having a floor, a pair of opposing side walls, and a weather-resistant quarter panel of molded polymeric material removably secured to each of the side walls. Each quarter panel can be disengaged from a respective side wall by hand by a person, without requiring tools. The aesthetic appearance of each of the quarter panels can match the aesthetic appearance of the floor and/or one or more trim components within a passenger compartment of the open-air vehicle. Removable quarter panels may also include various amenities found within the passenger compartment of vehicles such as cup holders, armrests, and receptacles for storing articles.

### RELATED APPLICATION

This application claims the benefit of and priority to U.S. Provisional Patent Application No. 60/611,763 filed Sep. 21, 2004, the disclosure of which is incorporated herein by reference as if set forth in its entirety.

### FIELD OF THE INVENTION

The present invention relates generally to vehicles and, more particularly, to open-air style vehicles.

### BACKGROUND OF THE INVENTION

Open-air style vehicles, such as the Jeep® Wrangler® brand vehicle (Daimler-Chrysler AG, Stuttgart, Germany), have open back ends (cargo areas), and also have removable, canvas tops, which can allow a driver to enjoy the openness of the vehicle while driving. As illustrated in FIG. 1, the cargo area 1 of an open-air style vehicle 2 is defined by the space between the front seats 4 and the pivotable tailgate 6. Rear seats 7 may be installed in the open cargo areas of these vehicles. Although a canvas top is generally provided to shield against rain and direct sunlight, the cargo area typically remains uncovered. The cargo area of open-air style vehicles typically does not have trim components, such as carpeting, quarter panels, etc. Accordingly, a passenger in the rear seat of such a vehicle is exposed to the sheet metal of the vehicle. During summer months especially, the sheet metal of the vehicle can become uncomfortably hot.

### SUMMARY OF THE INVENTION

In view of the above discussion, an open-air vehicle, according to embodiments of the present invention, includes a rear cargo area having a floor, a pair of opposing side walls, and a weather-resistant quarter panel of molded polymeric material removably secured to each of the side walls. Each quarter panel can be disengaged from a respective side wall by hand by a person, without requiring tools.

According to embodiments of the present invention, the aesthetic appearance of each of the quarter panels substantially matches the aesthetic appearance of the floor and/or one or more trim components within a passenger compartment of the open-air vehicle. Removable quarter panels, according to embodiments of the present invention, may include various amenities found within the passenger compartment of vehicles including, but not limited to, cup holders, armrests, and receptacles for storing articles.

### BRIEF DESCRIPTION OF THE DRAWINGS

The accompanying drawings, which form a part of the specification, illustrate key embodiments of the present invention. The drawings and description together serve to fully explain the invention.

FIG. 1 is a rear perspective view of an open-air style vehicle in which embodiments of the present invention may be incorporated.

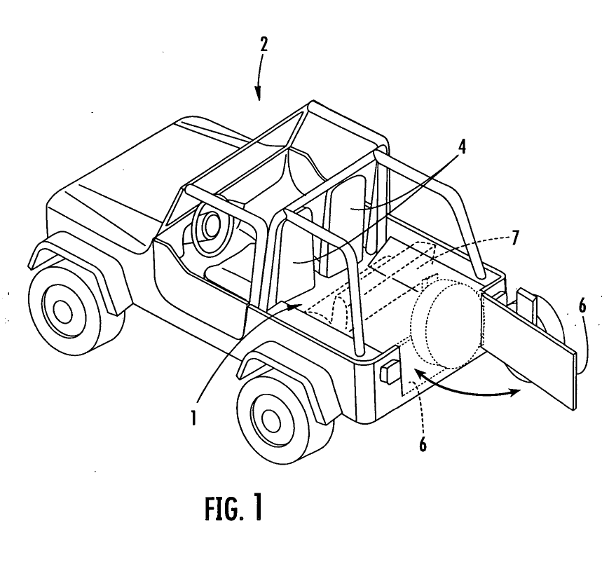

FIG. 2 is a perspective view of a removable/washable quarter panel for an open-air style vehicle, according to embodiments of the present invention.

FIG. 3 is a partial perspective view of the cargo area of an open-air style vehicle with a removable/washable quarter panel installed therein, according to embodiments of the present invention.

FIG. 4 is a top plan view of the cargo area of an open-air style vehicle with removable/washable quarter panels installed therein, according to embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention.

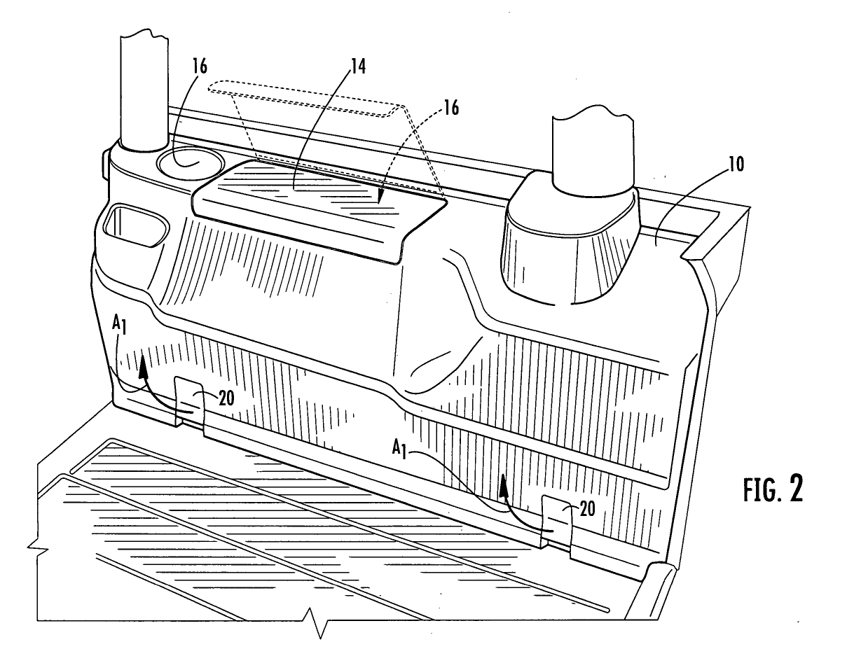

Referring now to FIGS. 2-4, a quarter panel 10 for use in open-air style vehicles, according to embodiments of the present invention, is illustrated. The illustrated quarter panel 10 is formed from weather-resistant, durable material and is configured to be easily installed and removed from a vehicle. In the illustrated embodiment, the removable quarter panel 10 includes an armrest 14 and a cupholder 16. The illustrated armrest 14 is pivotally mounted to the quarter panel and can be raised as shown to allow access to a storage receptacle 16 within the quarter panel 10. However, embodiments of the present invention do not require a storage receptacle. As such, armrest 14 may be secured to the quarter panel 10 in a conventional manner.

Quarter panels 10, according to embodiments of the present invention may be formed from various materials including, but not limited to, polymeric materials. Exemplary polymeric materials include, but are not limited to, polypropylene, polyethylene, polyamide, polyoxymethylene (POM), etc., in their natural, filled, reinforced, or blended formulations.

Cup holders 16 may be integrally formed within portions of the quarter panel 10 and/or may be separate attachments thereto. According to embodiments of the present invention, one or more receptacles (not illustrated) configured to receive articles therein may be formed within portions of the quarter panel 10. Receptacles may be integrally formed within portions of the quarter panel 10 and/or may be separate attachments thereto. As described above, storage receptacles may be provided within the quarter panel 10 and may be accessible via pivotal lids such as, for example, the armrest 14.

Removable quarter panels 10, according to embodiments of the present invention, may have various shapes and configurations and are not limited to the illustrated embodiments. Moreover, more than one cupholder (or no cupholders) may be provided. Various types and configurations of cupholders and/or article receptacles may be provided in quarter panels 10 according to embodiments of the present invention. The armrest 14 is preferably formed from a durable, weather-resistant material, also.

Removable quarter panels 10, according to embodiments of the present invention, may be secured to a vehicle in various ways including, but not limited to, fasteners (e.g., rivets, bolts, screws, etc.), quick-release devices (e.g., quarter turn bolts, latches, hook and loop fasteners, etc.), adhesives, etc. Fasteners utilized in accordance with embodiments of the present invention and that facilitate easy removal and installation of the quarter panels are within the scope of knowledge of those skilled in the art.

In the illustrated embodiment, quick release devices 20 are provided to facilitate quick removal and installation of the quarter panel 10 without requiring tools. The illustrated quick release devices 20 are latches that release in a conventional manner by an upward motion as indicated by arrows A₁. Securing the quarter panel 10 in place is accomplished by a reverse, downward motion of the latches 20, as would be understood by those skilled in the art. Because tools are not required, removal and reattachment of quarter panels 10 are greatly simplified. Various types of latches and other quick release devices may be used in accordance with embodiments of the present invention, as would be understood by those skilled in the art.

Removable quarter panels 10, according to embodiments of the present invention, may be configured to attenuate sound, such as road noise etc. In addition, removable quarter panels 10, according to embodiments of the present invention, may be designed to match the design and/or color of other vehicle interior trim materials.

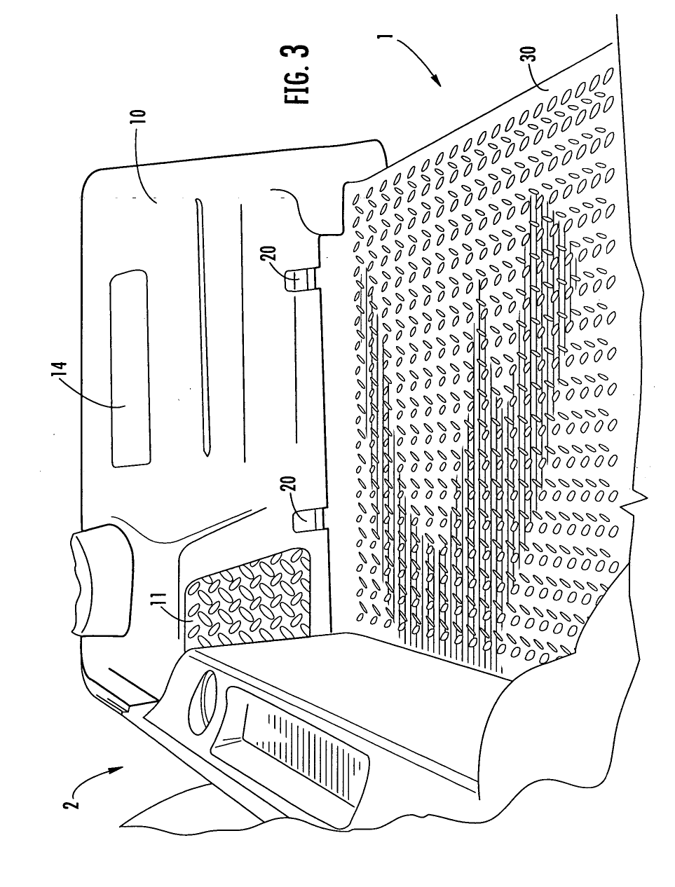

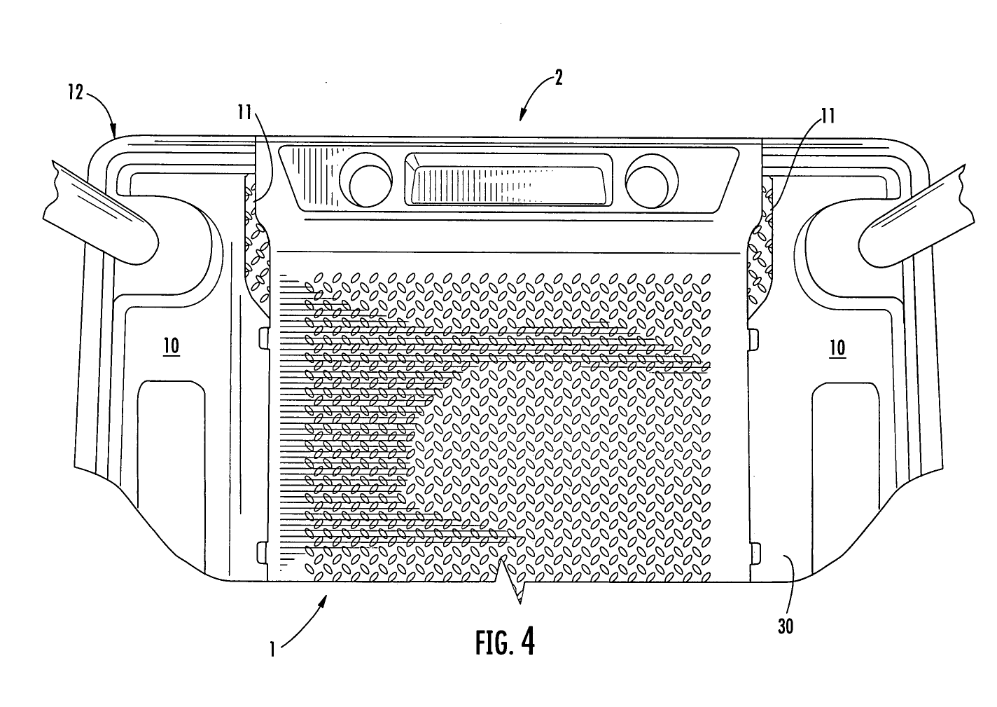

Quarter panels according to embodiments of the present invention may have an aesthetic appearance that substantially matches the aesthetic appearance of one or more portions of a vehicle including the floor, the tailgate, and/or other interior trim components. The term “aesthetic appearance” is intended to mean the overall visual appearance and includes, but is not limited to color, style, patterns, etc. In the illustrated embodiment of FIGS. 3-4, the rear cargo area 1 of the open-air vehicle 2 includes a floor 30 having a pattern formed thereon. The illustrated quarter panels 10 have a portion 11 with an aesthetic appearance that substantially matches the aesthetic appearance of the floor pattern.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. The invention is defined by the following claims, with equivalents of the claims to be included therein.

That which is claimed is:

1. An open-air vehicle, comprising:
a rear cargo area comprising a pair of opposing side walls; and
a weather-resistant quarter panel of molded polymeric material removably secured to each of the side walls, wherein each weather-resistant quarter panel can be disengaged from a respective side wall by hand by a person, without requiring tools.

2. The open-air vehicle of claim 1, wherein the rear cargo area comprises a floor, and wherein the aesthetic appearance of each of the quarter panels substantially matches the aesthetic appearance of the floor.

3. The open-air vehicle of claim 1, wherein the aesthetic appearance of each of the quarter panels substantially matches the aesthetic appearance of one or more trim components within a passenger compartment of the open-air vehicle.

4. The open-air vehicle of claim 1, wherein at least one of the quarter panels comprises one or more cup holders.

5. The open-air vehicle of claim 1, wherein at least one of the quarter panels comprises an armrest.

6. The open-air vehicle of claim 1, wherein at least one of the quarter panels comprises a receptacle formed therein that is configured to receive articles therein.

7. The open-air vehicle of claim 1, wherein each quarter panel is removably secured to a respective side wall via one or more quick-release fasteners.

8. The open-air vehicle of claim 1, wherein the rear cargo area comprises a tailgate door pivotally secured thereto and movable about a substantially vertical axis between an open position and a closed position, wherein the tailgate door comprises an interior portion; and
a weather-resistant cargo storage apparatus secured to the tailgate door interior portion.

9. The open-air vehicle of claim 8, wherein the cargo storage apparatus has an aesthetic appearance that substantially matches the aesthetic appearance of each of the quarter panels.

10. An open-air vehicle, comprising:
a rear cargo area comprising a floor and a pair of opposing side walls;
a weather-resistant quarter panel of molded polymeric material removably secured to each of the side walls, wherein each weather-resistant quarter panel is removably secured to a respective side wall via one or more quick-release fasteners and can be disengaged from a respective side wall by hand by a person, without requiring tools, and wherein the aesthetic appearance of each of the quarter panels substantially matches the aesthetic appearance of the floor.

11. The open-air vehicle of claim 10, wherein the aesthetic appearance of each of the quarter panels substantially matches the aesthetic appearance of one or more trim components within a passenger compartment of the open-air vehicle.

12. The open-air vehicle of claim 10, wherein at least one of the quarter panels comprises one or more cup holders.

13. The open-air vehicle of claim 10, wherein at least one of the quarter panels comprises an armrest.

14. The open-air vehicle of claim 10, wherein at least one of the quarter panels comprises a receptacle formed therein that is configured to receive articles therein.

15. The open-air vehicle of claim 10, wherein the rear cargo area comprises a tailgate door pivotally secured thereto and movable about a substantially vertical axis between an open position and a closed position, wherein the tailgate door comprises an interior portion; and
a weather-resistant cargo storage apparatus secured to the tailgate door interior portion.

16. The open-air vehicle of claim 15, wherein the cargo storage apparatus has an aesthetic appearance that substantially matches the aesthetic appearance of each of the quarter panels.

17. An open-air vehicle, comprising:
a rear cargo area comprising a pair of opposing side walls;
a passenger seat secured within the rear cargo area; and
a weather-resistant quarter panel of molded polymeric material removably secured to each of the side walls, wherein each quarter panel comprises a cup holder and an arm rest, and wherein each quarter panel can be disengaged from a respective side wall by hand by a person, without requiring tools

18. The open-air vehicle of claim 17, wherein the rear cargo area comprises a floor, and wherein the aesthetic appearance of each of the quarter panels substantially matches the aesthetic appearance of the floor.

19. The open-air vehicle of claim 17, wherein the aesthetic appearance of each of the quarter panels substantially matches the aesthetic appearance of one or more trim components within a passenger compartment of the open-air vehicle.

20. The open-air vehicle of claim 17, wherein each quarter panel is removably secured to a respective side wall via one or more quick-release fasteners.
